(19) United States
(12) Patent Application Publication
(10) Pub. No.: US 2017/0163814 A1
(43) Pub. Date: Jun. 8, 2017

(54) Method and Electronic Device for Realizing the Remote Control of Call Transfer

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Gang WANG, Beijing (CN)

(21) Appl. No.: 15/241,433

(22) Filed: Aug. 19, 2016

Related U.S. Application Data
(63) Continuation of application No. PCT/CN2016/089254, filed on Jul. 7, 2016.

(30) Foreign Application Priority Data
Dec. 8, 2015 (CN) 201510896512.5

(51) Int. Cl. H04M 3/58; H04M 3/42

(52) U.S. Cl. CPC H04M 3/58; H04M 3/42229

(57) ABSTRACT

The present disclosure discloses a method and an electronic device for realizing remote control of call transfer, including: receiving a message sent by a third-party mobile phone; analyzing the content of the message, and judging whether it is a request for initiating call transfer; acquiring a password for initiating call transfer according to the message; determining whether the password for initiating call transfer is correct, if yes, initiating a call transfer mode; if not, sending a failure of call transfer request back to the third-party mobile phone. Therefore, by the method and the system for realizing remote control of call transfer, the problem in prior art that a call transfer function of a mobile phone that is left at a place can only be opened by manually calling the operator may be solved.

### CROSS-REFERENCE TO RELATED APPLICATION

This application is a continuation of International PCT Patent Application No. PCT/CN2016/089254, filed Jul. 7, 2016 (attached hereto as an Appendix), and claims benefit/priority of Chinese patent application No.201510896512.5, filed with the State Intellectual Property Office of China on 10 Dec. 8, 2015, which are all incorporated herein by reference in entirety.

### FIELD OF TECHNOLOGY

The present disclosure relates to the technical field of mobile communications, and in particular, to a method and an electronic device for realizing remote control of call transfer.

### BACKGROUND

Due to the lowering of the prices of mobile phones and the incompatibility of the 3G/4G network standards of Chinese operators, more and more people have more than two mobile phones. In busy work and life, it often occurs that a mobile phone is left at home or in other places. In such a case, a very important call may be missed. Usually, people will go back to the place where the mobile phone is left, which may lead to a high time and traffic cost.

Apart from this, call transfer may be set for a SIM card of the mobile phone that is left at a place. Call transfer is a basic network service provided by a communication operator. After a call transfer service has been opened for a certain number or SIM card, a user may set a call transfer condition and a destination number, and all incoming calls that meet the call transfer condition will be transferred to the destination number. Usually, there are two modes to set a call transfer: according to one mode, a third-party mobile phone may be used to call the SIM card operator of the mobile phone that is left at a place, so as to manually set a call transfer service for the mobile phone that is left at a place; according to the other mode, a function of setting call transfer is provided on the mobile phone that is left at a place, and a user may select this function such that the mobile phone may initiate a call transfer and automatically send a request to the corresponding operator of the SIM card for opening call transfer, afterwards, the operator may receive the request and open the call transfer service for the SIM card in the mobile phone.

However, for a mobile phone that is left at a place, the call transfer function for the SIM card in the mobile phone that is left at a place can only be initiated manually by the first mode. Thus, the mode in which the user initiates the call transfer function will be complex and troublesome. Moreover, the call transfer function may be set viciously, and personal privacy and security will both be threatened. For example, the call transfer function for a certain SIM card may be initiated by others viciously via calling the operator of the SIM card.

### SUMMARY

Therefore, it is an object of the present disclosure to put forward a method and an electronic device for realizing remote control of call transfer, thereby the problem in prior art that the call transfer function of a mobile phone that is left at a place can only be initiated by manually calling the operator may be solved.

According to a first aspect, the method for realizing remote control of call transfer provided by the disclosure based on the above object includes the steps of:

receiving a message sent by a third-party mobile phone;

analyzing the content of the message, and judging whether it is a request for initiating call transfer;

acquiring a password for initiating call transfer according to the message; and

determining whether the password for initiating call transfer is correct, if yes, initiating a call transfer mode; if not, sending a failure of call transfer request back to the third-party mobile phone.

In some embodiments, after receiving a message sent by a third-party mobile phone, the method further includes:

acquiring the number of the third-party mobile phone;

retrieving a preset call transfer directory, in which the numbers that can initiate the call transfer mode are stored;

determining whether the number of the third-party mobile phone is included in the call transfer directory; and

analyzing the content of the message and judging whether it is a request for initiating call transfer, if the number of the third-party mobile phone is included; or, sending a failure of call transfer request back to the third-party mobile phone if the number of the third-party mobile phone is not included.

In some embodiments, the step of analyzing the content of the message and judging whether it is a request for initiating call transfer includes:

determining whether the request for initiating call transfer conforms to a preset short message format, wherein the preset short message format is: KT#password for initiating call transfer#call transfer type#receiving number for transferred calls; and

acquiring a password for initiating call transfer according to the message if it conforms to the preset short message format; or, sending a failure of call transfer request back to the third-party mobile phone if the message does not conform to the preset short message format.

In some embodiments, after the determining that the request for initiating call transfer conforms to the preset short message format, the method further includes:

abstracting the receiving number for transferred calls from the short message;

retrieving a preset receiving directory, in which the numbers that calls to the mobile phone can be transferred to are stored;

determining whether the receiving number for transferred calls is included in the receiving directory; and

acquiring a password for initiating call transfer according to the message if the receiving number for transferred calls is included; or, sending a failure of call transfer request back to the third-party mobile phone if the receiving number for transferred calls is not included.

In some embodiments, before initiating the call transfer mode, the method includes: acquiring a network mode that the mobile phone currently operates on, and initiating a call transfer mode corresponding to the network mode.

According to a second aspect, the disclosure further provides a computer storage medium on which a program is stored, when executed, the program may carry out part of or all of the steps in each implementation mode of the above method for realizing remote control of call transfer according to the disclosure.

According to a third aspect, the disclosure further provides an electronic device that includes at least one processor and a memory, wherein instructions executable by the at least one processor are stored in the memory, and the instructions are configured to carry out any one of the above methods for realizing remote control of call transfer according to the disclosure.

It may be seen from the above description that, in the method and the electronic device for realizing remote control of call transfer according to the disclosure, a message sent by a third-party mobile phone is received; the content of the message is analyzed, and it is judged whether the content of the message is a request for initiating call transfer; a password for initiating call transfer is acquired according to the message; and it is determined whether the password for initiating call transfer is correct, if yes, a call transfer mode is initiated, if not, a failure of call transfer request is sent back to the third-party mobile phone. Therefore, a remote control of a call transfer function of a mobile phone may be realized, without the need to manually call an operator for setting call transfer, and hence the service quality and security of the call transfer service may be improved.

### BRIEF DESCRIPTION OF THE DRAWINGS

In order to more clearly illustrate the technical solutiosns of the embodiments of the disclosure or of the prior art, the drawings that are needed in the description of the embodiments or the prior art will be briefly introduced below. Apparently, the drawings in the description below merely illustrate some embodiments of the invention, and other drawings may also be obtained by one of ordinary skills in the art according to these drawings without creative work.

FIG. 1 is a schematic flow chart of a method for realizing remote control of call transfer according to the first embodiment of the disclosure;

FIG. 2 is a schematic flow chart of a method for realizing remote control of call transfer according to a reference embodiment of the disclosure;

FIG. 3 is a structural representation of a system for realizing remote control of call transfer according to the disclosure;

FIG. 4 is a structural representation of a system for realizing remote control of call transfer according to a reference embodiment of the disclosure; and

FIG. 5 is an structural diagram of an electronic device according to a reference embodiment of the disclosure.

### DETAILED DESCRIPTION

The disclosure will be further discussed in detail below in conjunction with the specific embodiments together with the drawings to make the objects, technical solutions and advantages of the disclosure more clear.

In the present situation of call transfer on a mobile phone, a remote automatic control on setting a call transfer function for a SIM card of the mobile phone cannot be realized according to an operation requirement of a user. As a result, for a remote mobile phone, call transfer function of a SIM card can only be manually set by calling the service number of the operator manually. In order to solve such a problem, the inventors, from the perspective of the user, realize that a user hopes to be able to automatically control the call transfer function of a SIM card remotely. Therefore, the concept of the present disclosure lies in that an operation on the call transfer function of a remote mobile phone is realized by a third-party mobile phone.

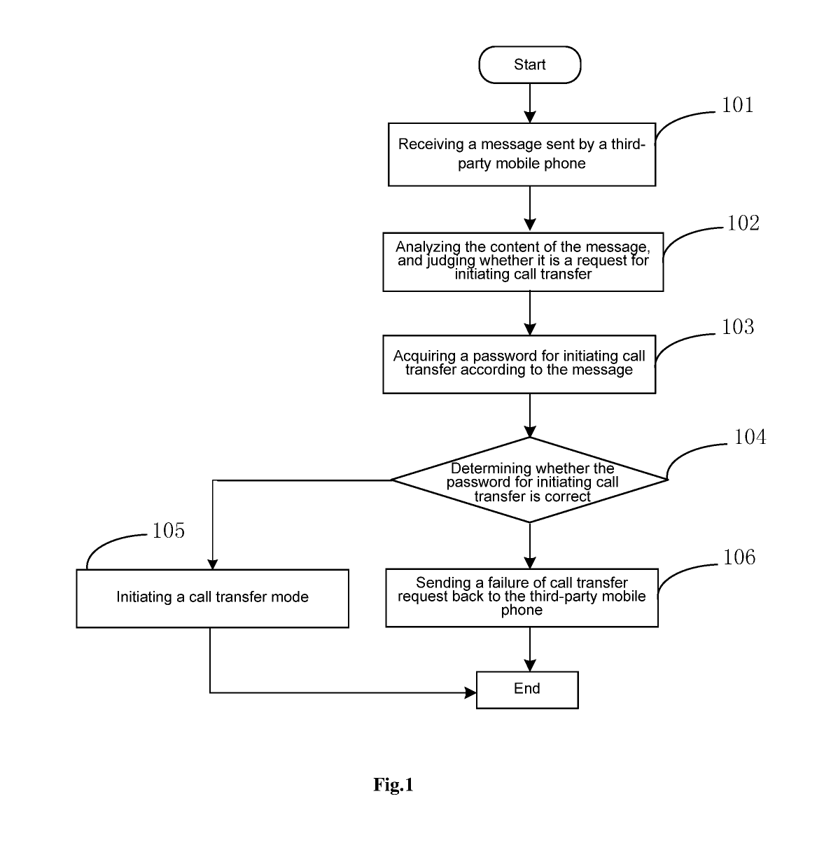

Referring to FIG. 1, it is a schematic flow chart of a method for realizing remote control of call transfer according to the first embodiment of the disclosure, wherein the method for realizing remote control of call transfer includes:

In step 101: a message sent by a third-party mobile phone is received.

In this embodiment, the mobile phone that is left at a place may receive a message sent by a third-party mobile phone. Wherein, the message may be a short message, a WeChat message and a mail, etc.

In step 102: the content of the message is analyzed, and it is judged whether the content is a request for initiating call transfer.

Preferably, the request for initiating call transfer is set with a specified format.

Preferably, the request for initiating call transfer is in the form of a short message, and the format of the short message is: KT#password for initiating call transfer#call transfer type#receiving number for transferred calls. Wherein, the password for initiating call transfer refers to a password for initiating a call transfer mode. Moreover, the call transfer type may be different types input according to user requirement, for example, an unconditional call transfer. furthermore, the receiving number for transferred calls refers to a number that may receive communication content from the mobile phone after the call transfer mode is initiated.

In step 103: a password for initiating call transfer is acquired according to the message.

Wherein, a password for initiating call transfer is included in the request for initiating call transfer, and the password for initiating call transfer may be abstracted from the request for initiating call transfer.

In step 104: it is determined whether the password for initiating call transfer is correct, if yes, it turns to step 105; if not, it turns to step 106.

It should be noted that, a password for initiating call transfer is set in advance on the mobile phone that is left at a place, and it may determine whether the password for initiating call transfer in the request is correct by comparing the password for initiating call transfer in the request with the preset password for initiating call transfer.

In step 105: the call transfer mode is initiated.

Preferably, the network mode that the mobile phone currently operates on is acquired. Then, a call transfer mode corresponding to the network mode is initiated according to the network mode. It should be noted that, in the prior art, based on different network modes, respective call transfer modes for a mobile phone are also different. Preferably, the network mode that the mobile phone currently operates on may be acquired by looking up/searching the network modes that are supported by the MODEN protocol stack of the mobile phone, which is prepared for setting call transfer. For example, by looking up the MODEN protocol stack of the mobile phone, it is obtained that the network mode that currently operates is CDMA, thus a CDMA call transfer mode will be initiated on the mobile phone.

In step 106: a failure of call transfer request is sent back to the third-party mobile phone.

In this embodiment, when it is determined that the password for initiating call transfer in the request is not correct, the mobile phone that is prepared for setting call transfer may send a short message to the third-party mobile phone and inform the third-party mobile phone that the call transfer request failed.

As another embodiment of the disclosure, after step 101 is performed, the number of the third-party mobile phone may be acquired. Then, a preset call transfer directory is retrieved/searched, and it is determined whether the number of the third-party mobile phone is included in the call transfer directory; if the number of the third-party mobile phone is included, it may turn to step 102; if the number of the third-party mobile phone is not included, it may directly turn to step 106. In this embodiment, the call transfer directory is set in advance in the mobile phone that is prepared for setting call transfer, and the numbers that can initiate the call transfer mode for the mobile phone are stored in the call transfer directory. That is, by setting the call transfer directory and the above process, the safety of initiating the call transfer mode on the mobile phone that is prepared for setting call transfer via a third-party mobile phone may be further ensured.

In another preferred embodiment of the disclosure, when step 102 is performed, it is determined whether the request for initiating call transfer conforms to a preset short message format. If it conforms to the preset short message format, it goes to step 103; if it does not conform to the preset request format, it directly turns to step 106. Preferably, after it is determined that the request for initiating call transfer conforms to the preset request format, the receiving number for transferred calls is abstracted from the short message, and a preset receiving directory is retrieved. Wherein, the numbers that calls to the mobile phone can be transferred to are stored in the receiving directory. Then, it is determined whether the receiving number for transferred calls is included in the receiving directory. According to the determination result, if the receiving number for transferred calls is included, it goes to step 103; if the receiving number for transferred calls is not included, it directly turns to step 106.

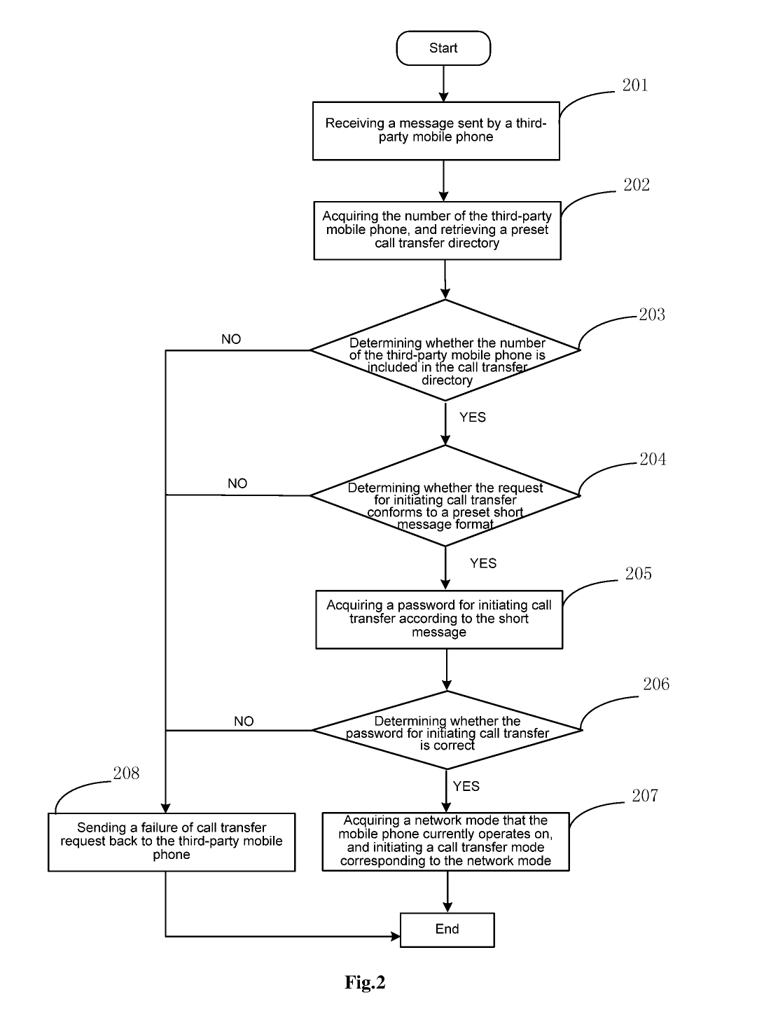

As a referable embodiment, referring to FIG. 2, the method for realizing remote control of call transfer may specifically include the steps of:

In step 201: a message sent by a third-party mobile phone is received;

In step 202: the number of the third-party mobile phone is acquired, and a preset call transfer directory is retrieved; wherein, the numbers that can initiate the call transfer mode for the mobile phone are stored in the call transfer directory;

In step 203: it is determined whether the number of the third-party mobile phone is included in the call transfer directory; if included, it may turn to step 204; if not included, it may turn to step 208.

Wherein, the numbers that calls to the mobile phone can be transferred to are stored in the receiving directory.

In step 204: it is determined whether the request for initiating call transfer conforms to a preset short message format, if yes, it turns to step 205, and if not, it turns to step 208.

Wherein, the short message format is: KT#password for initiating call transfer#call transfer type#receiving number for transferred calls.

In step 205: a password for initiating call transfer is acquired according to the short message.

In step 206: it is determined whether the password for initiating call transfer is correct, if yes, it turns to step 207, and if not, it turns to step 208.

In step 207: the network mode that the mobile phone currently operates on is acquired, and a call transfer mode corresponding to the network mode is initiated.

In step 208: a failure of call transfer request is sent back to the third-party mobile phone.

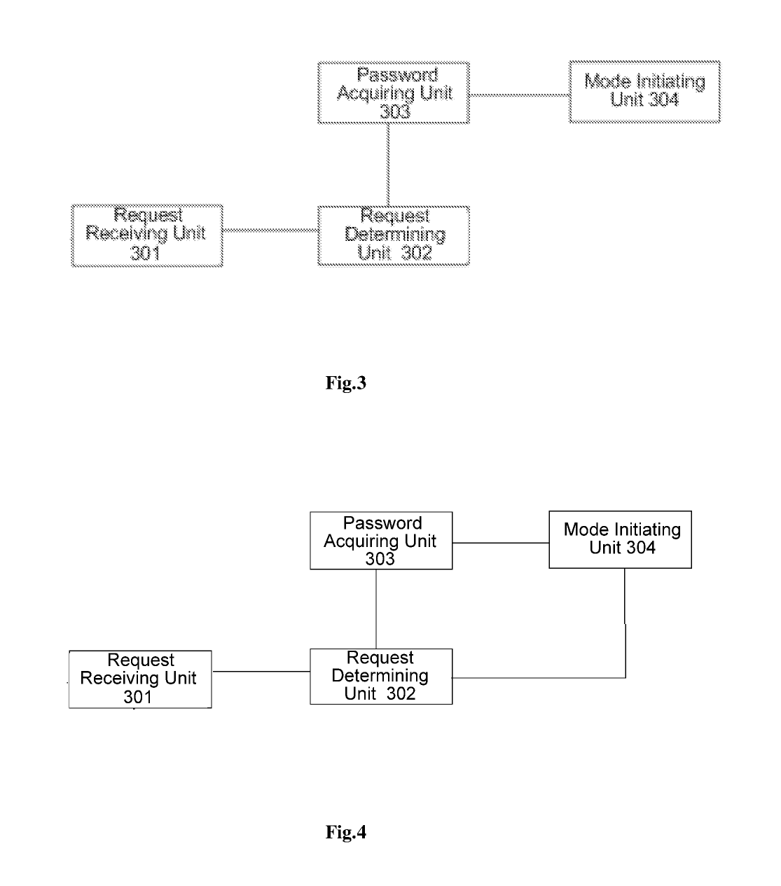

In another aspect of the disclosure, there further provides a system for realizing remote control of call transfer. As shown in FIG. 3, the system for realizing remote control of call transfer includes a request receiving unit 301, a request determining unit 302, a password acquiring unit 303 and a mode initiating unit 304 that are connected in turn. Wherein, the request receiving unit 301 is configured for receiving a message sent by a third-party mobile phone. The request determining unit 302 is configured for analyzing the content of the message and judging whether it is a request for initiating call transfer. The password acquiring unit 303 is configured for acquiring a password for initiating call transfer according to the message. The mode initiating unit 304 is configured for determining whether the password for initiating call transfer is correct, if yes, initiating a call transfer mode, and if not, sending back to the third-party mobile phone a failure of call transfer request.

It should be noted that, before initiating the call transfer mode, the mode initiating unit 304 may acquire the network mode that the mobile phone currently operates on and then initiate a call transfer mode corresponding to the network mode.

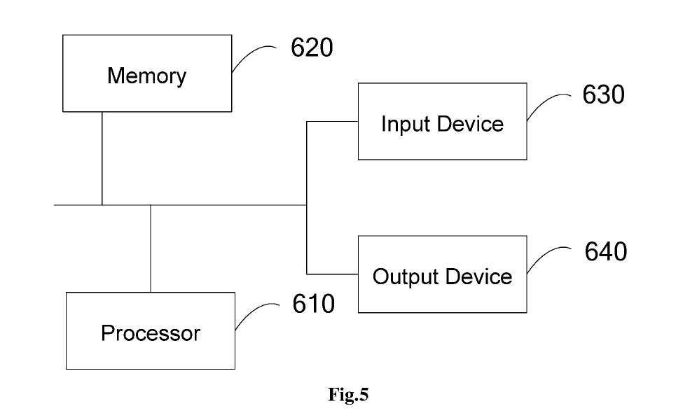

As a referable embodiment of the system, as shown in FIG. 4, the request determining unit 302 may acquire the number of the third-party mobile phone from the request receiving unit 301 and retrieve a preset call transfer directory. Then, the request determining unit 302 determines whether the number of the third-party mobile phone is included in the call transfer directory, if included, the request determining unit 302 will be connected with the password acquiring unit 303; if not included, the request determining unit 302 will be connected with the mode initiating unit 304, and the mode initiating unit 304 directly sends back a failure of call transfer request to the third-party mobile phone.

In a preferred reference embodiment, the request determining unit 302 may further determine whether the request for initiating call transfer conforms to a preset short message format. Wherein, the preset request format is: KT#password for initiating call transfer#call transfer type#receiving number for transferred calls. According to the determination result, if the request conforms to the preset short message format, the request determining unit 302 will be connected with the password acquiring unit 303; if the request does not conform to the preset request format, the request determining unit 302 will be connected with the mode initiating unit 304, and the mode initiating unit 304 directly sends back a failure of call transfer request to the third-party mobile phone.

Preferably, after the request determining unit 302 determines that the request for initiating call transfer conforms to the preset short message format, it requires to abstract the receiving number for transferred calls from the request for initiating call transfer and retrieve a preset receiving directory. Wherein, the numbers that calls to the mobile phone can be transferred to are stored in the receiving directory. Then, the request determining unit 302 determines whether the receiving number for transferred calls is included in the receiving directory. According to the determination result, if the receiving number for transferred calls is included, the request determining unit 302 will be connected with the password acquiring unit 303; if the receiving number for transferred calls is not included, the request determining unit 302 will be connected with the mode initiating unit 304, and the mode initiating unit 304 directly sends back a failure of call transfer request to the third-party mobile phone.

It should be noted that, the specific implementation content of the system for realizing remote control of call transfer according to the disclosure has been illustrated in detail in the above method for realizing remote control of call transfer, and will not be repeatedly discussed here.

In conclusion, by the method and the system for realizing remote control of call transfer according to the disclosure, a mode of opening a call transfer function without the aid of manual call and manual labor is provided creatively, thereby an automatic control on the call transfer function of a remote mobile phone may be realized; moreover, the process of an automatic remote control may be carried out and performed securely and reliably, thus personal information of the owner of the mobile phone may be protected wonderfully. Therefore, the disclosure has a wide significance of popularization. Finally, the whole method and system for realizing remote control of call transfer is compact and hence easy to be constrained.

One embodiment of the disclosure further provides a computer storage medium on which a program is stored; when executed, the program may carry out part of or all of the steps in each implementation mode of the method for realizing remote control of call transfer according to the embodiments shown in FIG. 1-FIG. 2.

FIG. 5 is diagram illustrating a hardware structure of an electronic device for carrying out the method for realizing remote control of call transfer according to an embodiment of the disclosure. As shown in FIG. 5, the electronic device includes:

at least one processor 610 and a memory 620, wherein only one processor 610 is illustratively shown in FIG. 5.

The electronic device executing the method for realizing remote control of call transfer may also include: an input device 630 and an output device 640.

The processor 610, memory 620, input device 630 and output device 640 may be connected via a bus or other means, wherein a connecting bus is illustratively shown in FIG. 5.

The memory 620, as a non-volatile computer readable storage medium, may be used to store non-volatile software programs, non-volatile computer executable programs and modules, such as the program commands/modules corresponded to the method for realizing remote control of call transfer according to the embodiments in the present disclosure. The processor 610, by running non-volatile software programs, commands and modules stored in the memory 620, performs various functional applications and data processing of the server, i.e., carries out the method for realizing remote control of call transfer according to the above embodiments in the present disclosure.

The memory 620 may include a program storage area and a data storage area, wherein the program storage area may be used to store application programs needed by an operating system or by at least one function, and the data storage area may be used to store data created by running the device for realizing remote control of call transfer, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for realizing remote control of call transfer via a network connection. An example of such a network includes, but not limited to, internet, intranet, local area network, mobile communication network, and a combination thereof.

The input device 630 may receive input digital or character information, and generate key signal inputs concerned with user setting and functional control of the device for realizing remote control of call transfer. The output device 640 may include displaying means such as a display screen.

The at least one module is stored in the memory 620, and, when run by the at least one processor 610, executes the method for realizing remote control of call transfer according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like.;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console , E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned device examples are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for realizing remote control of call transfer, comprising the steps of:
receiving a message sent by a third-party mobile phone;
analyzing the content of the message, and judging whether it is a request for initiating call transfer;
acquiring a password for initiating call transfer according to the message; and
determining whether the password for initiating call transfer is correct, if yes, initiating a call transfer mode; if not, sending a failure of call transfer request back to the third-party mobile phone.

2. The method according to claim 1, wherein, after receiving a message sent by a third-party mobile phone, the method further comprises:
acquiring the number of the third-party mobile phone;
retrieving a preset call transfer directory, in which the numbers that can initiate the call transfer mode are stored;
determining whether the number of the third-party mobile phone is included in the call transfer directory; and
analyzing the content of the message and judging whether it is a request for initiating call transfer, if the number of the third-party mobile phone is included; or, sending a failure of call transfer request back to the third-party mobile phone if the number of the third-party mobile phone is not included.

3. The method according to claim 1, wherein, the step of analyzing the content of the message and judging whether it is a request for initiating call transfer comprises:
determining whether the request for initiating call transfer conforms to a preset short message format, wherein the preset short message format is: KT#password for initiating call transfer#call transfer type#receiving number for transferred calls; and acquiring a password for initiating call transfer according to the message if it conforms to the preset short message format; or, sending a failure of call transfer request back to the third-party mobile phone if the message does not conform to the preset short message format.

4. The method according to claim 3, wherein, after determining that the request for initiating call transfer conforms to the preset short message format, the method further comprises:
abstracting the receiving number for transferred calls from the short message;
retrieving a preset receiving directory, in which the numbers that calls to the mobile phone can be transferred to are stored;
determining whether the receiving number for transferred calls is included in the receiving directory; and
acquiring a password for initiating call transfer according to the message if the receiving number for transferred calls is included; or, sending a failure of call transfer request back to the third-party mobile phone if the receiving number for transferred calls is not included.

5. The method according to claim 1, wherein, before initiating the call transfer mode, the method comprises: acquiring a network mode that the mobile phone currently operates on, and initiating a call transfer mode corresponding to the network mode.

6. A non-transitory computer storage medium for storing computer executable instructions that are configured for:
receiving a message sent by a third-party mobile phone;
analyzing the content of the message, and judging whether it is a request for initiating call transfer;
acquiring a password for initiating call transfer according to the message; and
determining whether the password for initiating call transfer is correct, if yes, initiating a call transfer mode; if not, sending a failure of call transfer request back to the third-party mobile phone.

7. The non-transitory computer storage medium according to claim 6, wherein after receiving a message sent by a third-party mobile phone, the computer executable instructions are further configured for:
acquiring the number of the third-party mobile phone;
retrieving a preset call transfer directory, in which the numbers that can initiate the call transfer mode are stored;
determining whether the number of the third-party mobile phone is included in the call transfer directory; and
analyzing the content of the message and judging whether it is a request for initiating call transfer, if the number of the third-party mobile phone is included; or, sending a failure of call transfer request back to the third-party mobile phone if the number of the third-party mobile phone is not included.

8. The non-transitory computer storage medium according to claim 6, wherein the step of analyzing the content of the message and judging whether it is a request for initiating call transfer comprises:
determining whether the request for initiating call transfer conforms to a preset short message format, wherein the preset short message format is: KT#password for initiating call transfer#call transfer type#receiving number for transferred calls; and
acquiring a password for initiating call transfer according to the message if it conforms to the preset short message format; or, sending a failure of call transfer request back to the third-party mobile phone if the message does not conform to the preset short message format.

9. The non-transitory computer storage medium according to claim 8, wherein after determining that the request for initiating call transfer conforms to the preset short message format, the computer executable instructions are further configured for:
abstracting the receiving number for transferred calls from the short message;
retrieving a preset receiving directory, in which the numbers that calls to the mobile phone can be transferred to are stored;
determining whether the receiving number for transferred calls is included in the receiving directory; and
acquiring a password for initiating call transfer according to the message if the receiving number for transferred calls is included; or, sending a failure of call transfer request back to the third-party mobile phone if the receiving number for transferred calls is not included.

10. The non-transitory computer storage medium according to claim 6, wherein before initiating the call transfer mode, the computer executable instructions are further configured for: acquiring a network mode that the mobile phone currently operates on, and initiating a call transfer mode corresponding to the network mode.

11. An electronic device for realizing remote control of call transfer, comprising:
at least one processor; and
a memory communicably connected with the at least one processor, wherein instructions executable by the at least one processor are stored in the memory, and the instructions, when being executed by the at least one processor, cause the at least one processor to:
receive a message sent by a third-party mobile phone;
analyze the content of the message, and judge whether it is a request for initiating call transfer;
acquire a password for initiating call transfer according to the message; and
determine whether the password for initiating call transfer is correct, if yes, initiate a call transfer mode; if not, send a failure of call transfer request back to the third-party mobile phone.

12. The electronic device according to claim 11, wherein after receiving a message sent by a third-party mobile phone, the at least one processor is further caused to:
acquire the number of the third-party mobile phone;
retrieve a preset call transfer directory, in which the numbers that can initiate the call transfer mode are stored;
determine whether the number of the third-party mobile phone is included in the call transfer directory; and
analyze the content of the message and judging whether it is a request for initiating call transfer, if the number of the third-party mobile phone is included; or, send a failure of call transfer request back to the third-party mobile phone if the number of the third-party mobile phone is not included.

13. The electronic device according to claim 11, wherein the step to analyze the content of the message and judge whether it is a request for initiating call transfer comprises to:
determine whether the request for initiating call transfer conforms to a preset short message format, wherein the preset short message format is: KT#password for initiating call transfer#call transfer type#receiving number for transferred calls; and
acquire a password for initiating call transfer according to the message if it conforms to the preset short message format; or, send a failure of call transfer request back to the third-party mobile phone if the message does not conform to the preset short message format.

14. The electronic device according to claim 13, wherein after determining that the request for initiating call transfer conforms to the preset short message format, the at least one processor is further caused to:
abstract the receiving number for transferred calls from the short message;
retrieve a preset receiving directory, in which the numbers that calls to the mobile phone can be transferred to are stored;
determine whether the receiving number for transferred calls is included in the receiving directory; and
acquire a password for initiating call transfer according to the message if the receiving number for transferred calls is included; or, send a failure of call transfer request back to the third-party mobile phone if the receiving number for transferred calls is not included.

15. The electronic device according to claim 11, wherein before initiating the call transfer mode, the at least one processor is further caused to: acquire a network mode that the mobile phone currently operates on, and initiate a call transfer mode corresponding to the network mode.

16. The method according to claim 2, wherein the step of analyzing the content of the message and judging whether it is a request for initiating call transfer comprises:
determining whether the request for initiating call transfer conforms to a preset short message format, wherein the preset short message format is: KT#password for initiating call transfer#call transfer type#receiving number for transferred calls; and
acquiring a password for initiating call transfer according to the message if it conforms to the preset short message format; or, sending a failure of call transfer request back to the third-party mobile phone if the message does not conform to the preset short message format.

17. The method according to claim 16, wherein after determining that the request for initiating call transfer conforms to the preset short message format, the method further comprises:
abstracting the receiving number for transferred calls from the short message;
retrieving a preset receiving directory, in which the numbers that calls to the mobile phone can be transferred to are stored;
determining whether the receiving number for transferred calls is included in the receiving directory; and
acquiring a password for initiating call transfer according to the message if the receiving number for transferred calls is included; or, sending a failure of call transfer request back to the third-party mobile phone if the receiving number for transferred calls is not included.

18. The non-transitory computer storage medium according to claim 7, wherein the step of analyzing the content of the message and judging whether it is a request for initiating call transfer comprises:
determining whether the request for initiating call transfer conforms to a preset short message format, wherein the preset short message format is: KT#password for initiating call transfer#call transfer type#receiving number for transferred calls; and
acquiring a password for initiating call transfer according to the message if it conforms to the preset short message format; or, sending a failure of call transfer request back to the third-party mobile phone if the message does not conform to the preset short message format.

19. The non-transitory computer storage medium according to claim 18, wherein after determining that the request for initiating call transfer conforms to the preset short message format, the computer executable instructions are further configured for:
abstracting the receiving number for transferred calls from the short message;
retrieving a preset receiving directory, in which the numbers that calls to the mobile phone can be transferred to are stored;
determining whether the receiving number for transferred calls is included in the receiving directory; and
acquiring a password for initiating call transfer according to the message if the receiving number for transferred calls is included; or, sending a failure of call transfer request back to the third-party mobile phone if the receiving number for transferred calls is not included.

20. The electronic device according to claim 12, wherein the step to analyze the content of the message and judge whether it is a request for initiating call transfer comprises to:
determine whether the request for initiating call transfer conforms to a preset short message format, wherein the preset short message format is: KT#password for initiating call transfer#call transfer type#receiving number for transferred calls; and acquire a password for initiating call transfer according to the message if it conforms to the preset short message format; or, send a failure of call transfer request back to the third-party mobile phone if the message does not conform to the preset short message format.
